(19) United States
(12) Patent Application Publication
(10) Pub. No.: US 2024/0286869 A1
(43) Pub. Date: Aug. 29, 2024

(54) ELEVATOR ARRANGEMENT AND METHOD OF OPERATING ELEVATOR

(71) Applicant: KONE Corporation, Helsinki (FI)

(72) Inventors: Tapani TALONEN, Helsinki (FI); Tapio SIIRONEN, Helsinki (FI); Arto NAKARI, Helsinki (FI); Juhamatti NIKANDER, Helsinki (FI); Juha-Matti AITAMURTO, Helsinki (FI)

(73) Assignee: KONE Corporation, Helsinki (FI)

(21) Appl. No.: 18/656,975

(22) Filed: May 7, 2024

Related U.S. Application Data
(63) Continuation of application No. PCT/EP2021/087676, filed on Dec. 27, 2021.

(51) Int. Cl. B66B 5/00; B66B 1/32; B66B 1/34

(52) U.S. Cl. CPC B66B 5/0031; B66B 1/32; B66B 1/3492

(57) ABSTRACT

The elevator arrangement includes an elevator shaft, an elevator car configured to be moveable in a vertical direction along the elevator shaft, an electromechanical safety device to which safety device electrical power is supplied during operation of the elevator, and which safety device is configured to be triggered when power supply to the safety device is cut off, wherein triggering of the safety device is configured to prevent movement of the elevator car above at least one predetermined upper position and/or be-low at least one predetermined lower position, and a reserve power source, wherein the arrangement is configured to allow power supply from the reserve power source to the safety device for allowing moving of the elevator car above the at least one predetermined upper position and/or below the at least one predetermined lower position when normal power supply to the safety device is cut off.

### TECHNICAL FIELD OF THE INVENTION

The present invention concerns an elevator arrangement according to claim 1 or 12. The invention also concerns a method of operating an elevator, as defined in claim 11.

### BACKGROUND OF THE INVENTION

An elevator shaft is typically provided with a headroom and a pit. One of the functions of the headroom and the pit is to provide a refuge space that a person working or otherwise present in the shaft does not get squeezed between a moving elevator car and an end of the shaft. For providing a sufficient refuge space in the pit and in the headroom, the pit and the headroom need to have a certain height. This may be difficult or expensive to arrange especially in old buildings. To allow installing elevators in buildings where the space below the lowermost landing and above the uppermost landing is limited, elevators with a low pit and/or headroom have been developed.

For ensuring the safety of a low pit/low headroom elevator, different safety arrangements have been developed. However, there is still a need to further improve the safety of elevators with a low pit or headroom. Also, some safety arrangements may make rescuing of people from an elevator car that has been stopped due to a power failure or other fault difficult and time-consuming.

### SUMMARY OF THE INVENTION

An object of the invention is to provide improved elevator arrangements, which comprise an elevator shaft and an elevator car that is configured to be moveable in a vertical direction along the elevator shaft. Characterizing features of an elevator arrangement according to the invention are given in claim 1. Characterizing features of another elevator arrangement according to the invention are given in claim 12. A further object of the invention is to provide an improved method of operating an elevator arrangement comprising an electromechanical safety device to which safety device electrical power is supplied during operation of the elevator, and which safety device is configured to be triggered when power supply to the safety device is cut off, triggering of the safety device being configured to prevent movement of the elevator car above at least one predetermined upper position and/or below at least one predetermined lower position. The characterizing features of the method are given in claim 11.

An elevator arrangement according to the invention comprises an electromechanical safety device to which safety device electrical power is supplied during operation of the elevator, and which safety device is configured to be triggered when power supply to the safety device is cut off, wherein triggering of the safety device is configured to prevent movement of the elevator car above at least one predetermined upper position and/or below at least one predetermined lower position, and a reserve power source, wherein the arrangement is configured to allow power supply from the reserve power source to the safety device for allowing moving of the elevator car above the at least one predetermined upper position and/or below the at least one predetermined lower position when normal power supply to the safety device is cut off.

The elevator arrangement defined above allows bypassing of the electrical safety device. The safety device may be triggered when for instance opening of a door that provides access into the elevator shaft is detected. The safety device ensures that the elevator car cannot move to the ends of the shaft and sufficient free space is left between the roof of the elevator car and the top of the elevator shaft or between the bottom of the elevator car and the bottom of the elevator shaft.

However, the safety device may also be triggered for instance in case of a power failure. If there are people in the elevator car and the elevator car is between landings, the elevator car needs to be moved to a landing to allow rescuing of the people. The elevator car can move only to one direction by gravity. If the elevator car is close to the top of the elevator shaft and the load is small, it is likely that the inherent moving direction of the elevator car is upwards. If the safety device prevents moving of the elevator car upwards, rescuing of people becomes difficult. Either the safety device or a counterpart for the safety device needs to be manipulated manually, or an additional device is needed for pulling the elevator car to a landing where the people can be rescued. The first option requires in practice two technicians, which may delay rescuing of the people. Also, there is a risk that the manipulation of the safety device is not reversed, from which follows that the safety device does not work when needed. The second option makes the elevator more expensive. The elevator arrangement according to the invention solves these problems.

In the method according to the invention, electrical power is supplied to the safety device from a reserve power source to allow the elevator car to move above the at least one predetermined upper position and/or below the at least one predetermined lower position in case normal power supply to the safety device is cut off.

Another elevator arrangement according to the invention comprises a motor for moving the elevator car in the elevator shaft, the motor comprising a brake, an electrical brake release device for releasing the brake of the motor, means for detecting at least one event indicating a risk of a presence of a person in the elevator shaft outside the elevator car and/or means for determining the position of the elevator car and means for determining, based on the position of the elevator car, whether the elevator car is at a danger zone, wherein the arrangement is configured to prevent releasing of the brake of the motor when at least one event indicating a risk of a presence of a person in the elevator shaft outside the elevator car is detected and/or when the elevator car is at a danger zone.

The elevator arrangement defined above improves the safety of an elevator with a low pit and/or low headroom by preventing releasing of the brake when there is a risk that a person could be squeezed between the elevator shaft and the elevator car. An event indicating a risk of a presence of a person in the elevator shaft outside the elevator car could be, for instance, a load detected on the roof of the elevator car or opening of a hatch providing access from the elevator car into the elevator shaft. The danger zone can be an area of the elevator shaft where there is not the required free space or clearance between the elevator car and the elevator shaft. The danger zone can also mean an area of the elevator shaft where the elevator car moves to an unsafe direction if the brake is released. For instance, in case of a low headroom elevator that could mean an area where the elevator car moves inherently upwards.

Releasing of the brake could thus be allowed in case it is determined that the elevator car will move downwards when the brake is released.

According to an embodiment of the invention, the arrangement comprises detection means for detecting presence of a person or an inappropriate object on the roof of the elevator car and/or access onto the roof of the elevator car.

According to an embodiment of the invention, the arrangement comprises detection means for detecting presence of a person or an inappropriate object in the elevator shaft below the elevator car.

According to an embodiment of the invention, the arrangement comprises means for detecting access into the elevator shaft.

According to an embodiment of the invention, the arrangement is configured to prevent power supply from the reserve power source to the safety device when at least one of the following events is detected: presence of a person or an inappropriate object on the roof of the elevator car, access onto the roof of the elevator car, presence of a person or an inappropriate object in the elevator shaft below the elevator car, access into the elevator shaft. This improves the safety of the elevator arrangement, as moving of the elevator car above and/or below to the predetermined positions is prevented in case there is a risk that a person could be squeezed between the elevator car and the shaft.

According to an embodiment of the invention, the arrangement comprises a device and/or a function for allowing releasing of a brake of the elevator using power supplied from the reserve power source. The same reserve power source can thus be used for supplying electric power both to the safety device and a brake release device.

According to an embodiment of the invention, the safety device is configured to cooperate with a counterpart and one of the safety device and the counterpart is fastened to the elevator car and the other is fastened to the elevator shaft.

According to an embodiment of the invention, the arrangement comprises an upper counterpart arranged at the upper end of the elevator shaft and a lower counterpart arranged at the lower end of the elevator shaft or an upper safety device arranged at the upper end of the elevator shaft and a lower safety device arranged at the lower end of the elevator shaft. This allows determining both upper and lower limits for the movement of the elevator car.

According to an embodiment of the invention, the safety device comprises an engagement element that is configured to engage to the counterpart when the safety device is triggered and the elevator car moves to the at least one predetermined lower position or upper position.

According to an embodiment of the invention, the arrangement is configured to disable releasing of a brake of the elevator in at least one of the following cases:
a person or an inappropriate object on the roof of the elevator car is detected,
a person or an inappropriate object in the elevator shaft below the elevator car is detected,
the elevator car is at an upper danger zone extending to a predetermined distance from the upper end of the elevator shaft,
the elevator car is at a lower danger zone extending to a predetermined distance from the lower end of the elevator shaft,
a person or an inappropriate object on the roof of the elevator car is detected and the elevator car is at an upper danger zone extending to a predetermined distance from the upper end of the elevator shaft,
a person or an inappropriate object below the elevator car is detected and the elevator car is at a lower danger zone extending to a predetermined distance from the lower end of the elevator shaft.

### BRIEF DESCRIPTION OF THE DRAWINGS

Embodiments of the invention are described below in more detail with reference to the accompanying drawings, in which

FIG. 1 shows schematically a simplified view of an elevator,

FIG. 2 shows schematically an elevator arrangement according to an embodiment of the invention,

FIG. 3 shows schematically a situation where an elevator has been stopped by a safety device below the topmost landing, and

FIG. 4 show an example of an arrangement allowing disabling of releasing of a brake of an elevator.

### DETAILED DESCRIPTION OF EMBODIMENTS OF THE INVENTION

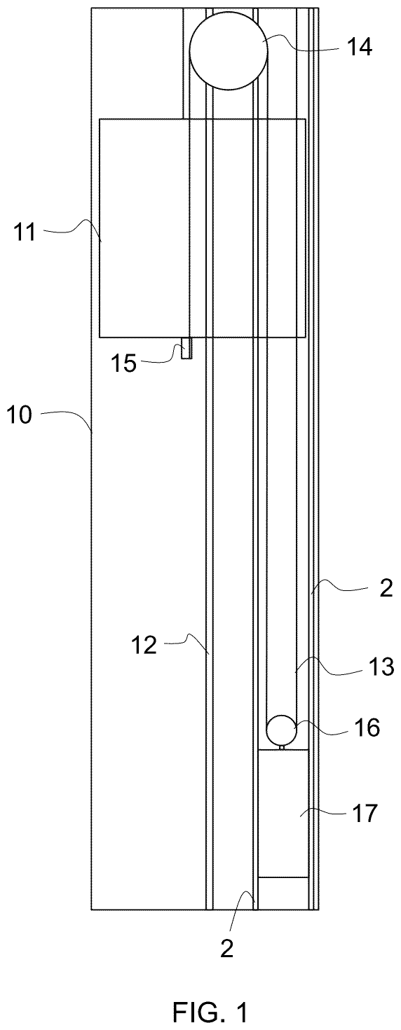

FIG. 1 shows a simplified schematic view of an elevator. The elevator comprises an elevator car 11 and a counterweight 17 which are configured to be moved in the vertical direction in an elevator shaft 10. For the sake of clarity, many parts of the elevator, such as end buffers for the elevator car 11 and the counterweight 17 have been omitted in FIG. 1. The elevator car 11 is connected to the counterweight 17 via a hoisting member 13. The hoisting member 13 can be, for example, a steel wire, a belt, such as a toothed belt or a flat belt, a carbon fiber rope or a coated rope. The elevator can comprise several hoisting members 13. The elevator car 11 and the counterweight 17 are connected to each other in such a way that they move to opposite directions in respect of each other. The elevator is further provided with a motor 14. The motor 14 is an electric motor. The motor 14 drives a sheave (not shown). The sheave can be connected to the motor 14 either directly or via a gear. As the sheave rotates, the hoisting member 13 moves and the elevator car 11 and the counterweight 17 are moved. In the example of FIG. 1, each end of the hoisting member 13 is fixed to the upper end of the shaft 10. The elevator car 11 is provided with two pulleys, of which only one pulley 15 is shown in FIG. 1. In the example of FIG. 1, the pulleys are arranged below the elevator car 1. The hoisting member 13 is engaged with the pulleys, which are configured to rotate freely about a rotation axis. The counterweight 17 is provided with a pulley 16 which is engaged with the hoisting member 13. Also the pulley 16 of the counterweight 17 is configured to rotate freely about a rotation axis. The sheave, the pulleys 15, 16 and the hoisting member 13 form the roping system of the elevator.

It should be noted that FIG. 1 shows only an example of a roping system of an elevator, and the hoisting member 13 could be arranged in many alternative ways. For example, the elevator car 11 could be provided with a single pulley. The counterweight 17 could be provided with more than one pulleys. A first end of the hoisting member 13 could be attached to the elevator car 11 and a second end of the hoisting member 13 could be attached to the counterweight 17. The hoisting member 4 could be guided around the sheave of the motor 14 twice.

In the example of FIG. 1, the motor 14 is arranged in the elevator shaft 10. The elevator is thus a machine-room-less elevator. However, the elevator could also be provided with a machine room located above the shaft 10 and the motor could be arranged in the machine room.

The elevator further comprises guide rails 2, 12. The guide rails 2, 12 are supporting structures that run in the vertical direction in the elevator shaft 10. The guide rails 2, 12 guide the vertical movement of the elevator car 11 and the counterweight 17. Also, the safety gear of the elevator cooperates with the guide rails 12 and the clamping jaws of the safety gear close around the guide and stop an overspeeding elevator car. The elevator of FIG. 1 comprises a pair of guide rails 2 that guide the counterweight 17 and another pair of guide rails 12 that guide the elevator car 11.

The elevator is connected to electric power network, from which electric power is supplied for operating for example the motor 14 of the elevator.

The elevator shaft 10 is typically provided with a headroom and a pit. The headroom is arranged at the upper end of the elevator shaft 10 and the pit is arranged at the bottom of the elevator shaft 10. One of the functions of the headroom and the pit is to provide a refuge space ensuring that a person working or otherwise present in the elevator shaft 10 does not get squeezed between a moving elevator car 11 and an end of the shaft 10. Typically the pit and the headroom are provided with end buffers, which prevent moving of the elevator car to the ends of the shaft. For providing a sufficient refuge space in the pit and in the headroom, the pit and the headroom need to have sufficient height. This may be difficult or expensive to arrange especially in old buildings retrofitted with elevators. Therefore, in many cases it can be beneficial and even necessary to make the pit and the headroom low.

The elevator of the figures is a so-called low-pit/low headroom elevator. This means that when the elevator car 11 is at the lowermost landing of the elevator shaft 10, the height of the pit, i.e. the distance between the bottom of the elevator shaft 10 and the bottom of the elevator car 11 is insufficient for forming a sufficient refuge space for a person present in the elevator shaft 10 below the elevator car 11. Similarly, when the elevator car 11 is at the uppermost landing of the elevator shaft 11, the height of the headroom, i.e. the distance between the upper end of the shaft 10 and the roof of the elevator car 11 is insufficient for forming a sufficient refuge space for a person on the roof of the elevator car 11. If the pit and/or the headroom is very low, the elevator could also be referred to as a no pit/no headroom elevator.

To improve the safety of the elevator, an elevator arrangement according to the invention is provided with an electromechanical safety device 1. During operation of the elevator, electrical power is supplied to the safety device 1. The safety device 1 is configured to be triggered when power supply to the safety device 1 is cut off. Triggering of the safety device 1 is configured to prevent movement of the elevator car 11 above a predetermined upper position and below a predetermined lower position.

In a low pit/low headroom elevator the safety device 1 helps forming a refuge space both at the lower end and at the upper end of the elevator shaft 10. If the elevator was provided with a high pit inherently providing a sufficient refuge space, triggering of the safety device 1 could be configured to only prevent movement of the elevator car 11 above a predetermined upper position. At the lower end of the elevator shaft 10, the elevator car 11 could be allowed to move to the lowermost landing despite triggering of the safety device 1. Similarly, if the elevator was provided with a high headroom inherently providing a sufficient refuge space, triggering of the safety device 1 could be configured to only prevent movement of the elevator car 11 below a predetermined lower position. At the upper end of the elevator shaft 10, the elevator car 11 could be allowed to move to the uppermost landing despite triggering of the safety device 1.

The safety device 1 can be connected to a safety circuit, where one or more predetermined events are configured to cut off power supply to the safety device 1. The predetermined events could include any event indicating a risk of a person being present in the elevator shaft 10, in particular below the elevator car 11 and/or above the elevator car 11. The predetermined events cutting off power supply to the safety device 1 could include, for instance, one or more of the following events: opening of a shaft access door 22, detection of a person on the roof of the elevator car 11, opening of a hatch providing access from the elevator car 11 onto the roof of the elevator car 11, opening of a hatch providing access from the elevator car 11 to the pit of the elevator shaft 10, opening of a hatch providing access onto the side of the elevator car 11, and detection of a person in the pit.

During normal operation of the elevator, electrical power is supplied to the safety device 1 from the electric power network 3. The elevator can be provided with means 4 for converting the electricity supplied from the electric power network suitable for the safety device 1. The means 4 can comprise, for instance, a transformer and/or a rectifier.

The safety circuit can comprise switches and a predetermined event indicating a risk of a person being present in the elevator shaft 10 can be configured to open a switch. The supply of electrical power to the safety device 1 can be implemented via the safety circuit so that opening of a switch of the safety circuit cuts off power supply to the safety device 1. Alternatively, the safety circuit could be configured so that each of the predetermined events generates a control signal that is used for controlling power supply to the safety device 1. It is also possible that one or more of the predetermined events opens a switch and one or more of the events generates a control signal cutting off the power supply to the safety device 1.

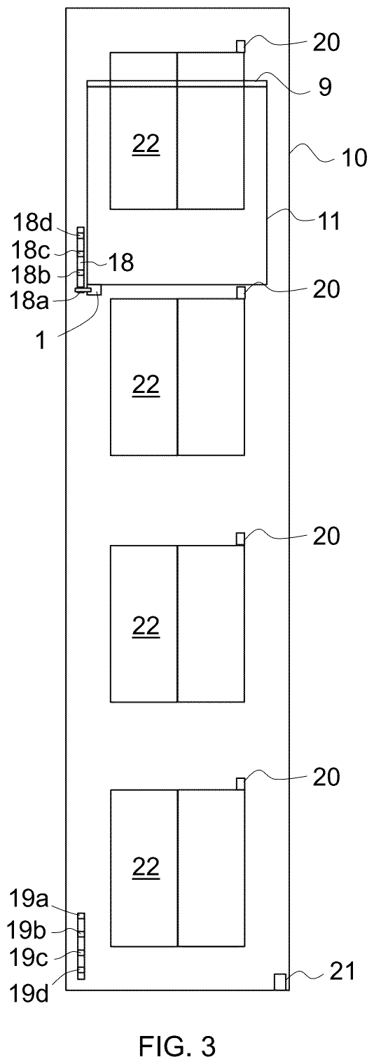

Power supply to the safety device 1 is cut off also in case of a power failure. The safety device 1 is thus triggered in case of a power failure and the elevator car 11 is prevented from moving below the predetermined lower limit and/or above the predetermined upper limit. A power failure may occur in a situation where there are people in the elevator car 11 and the elevator car 11 is between two landings. FIG. 3 shows schematically a situation where the elevator car 11 has been stopped between the uppermost landing and the landing below that.

To rescue people from the elevator car 11, the elevator car 11 needs to be moved to a landing. Without external power, the elevator car 11 can move only to one direction. Whether the direction is downwards or upwards depends on the position of the elevator car 11 and the load. When the elevator car 11 is close to the upper end of the elevator shaft 10, most of the weight of the hoisting member 13 is on the side of the counterweight 17. Depending on the load of the elevator, it is likely that the inherent moving direction of the elevator car 11 is upwards. Similarly, when the elevator car 11 is close to the lower end of the elevator shaft 10, most of the weight of the hoisting member 13 is on the side of the elevator car 11, and the elevator car 11 is likely to move only downwards without external power.

If the safety device 1 is triggered due to a power failure, there can thus occur a situation, where the safety device 1 prevents moving of the elevator car 11 to a direction, to which it would move by gravity. To allow rescuing of people from the elevator car 11 in such a situation, the elevator could be provided with a rescue device, which allows moving the elevator car 11 against gravity. For instance, in an elevator with a low headroom, the elevator could be provided with a rescue device, which allows pulling the elevator car 11 downwards when the elevator car 11 is close to the uppermost landing, but the safety device prevents moving the elevator car 11 upwards to the uppermost landing. A drawback of such a rescue device is that it increases the cost and complexity of the elevator. Also, rescuing of people requires two technicians, which can increase the time needed for rescuing the people from the elevator car 11.

An alternative way to allow rescuing of people is to manipulate the safety device 1 or a counterpart of the safety device 1 manually to allow moving of the elevator car 11 above or below a predetermined position. For instance, the safety device 1 can comprise an engagement element cooperating with a plate comprising holes and the holes can be covered by another plate or tool to allow the safety device 1 to move past the holes. This kind of solution is time-consuming and also involves the risk that the manipulation is not reversed after the rescue operation, which causes that the safety device 1 does not work when needed.

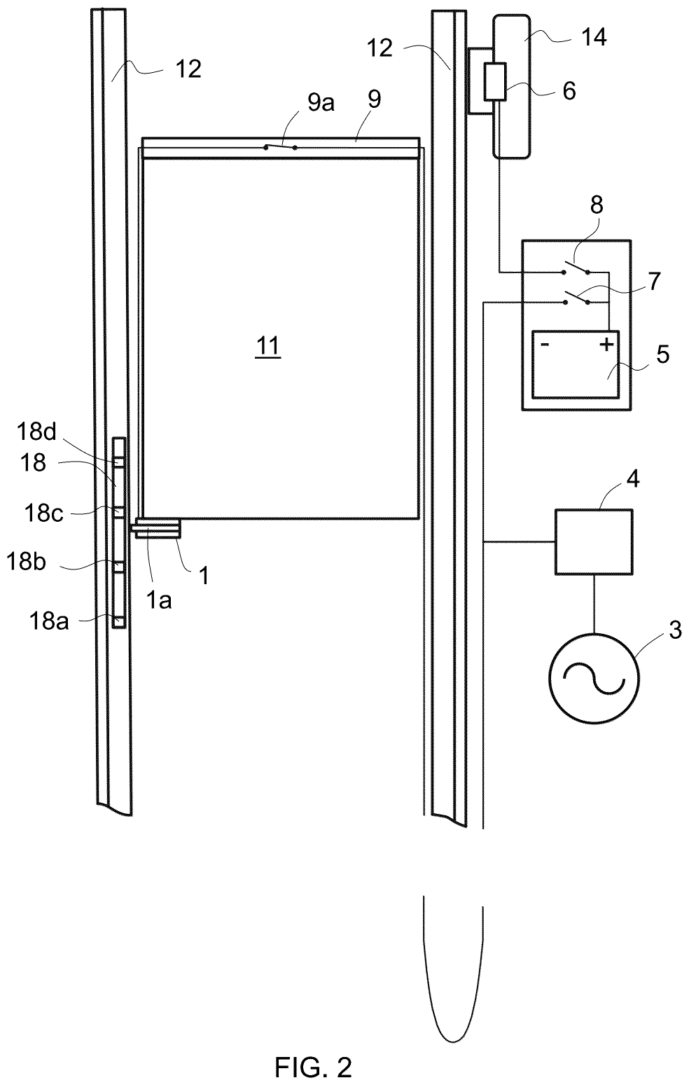

An elevator arrangement according to the invention comprises a reserve power source 5, which is schematically shown in FIG. 2. The arrangement is configured to allow power supply from the reserve power source 5 to the safety device 1 for allowing moving the elevator car 11 above the predetermined upper position and/or below the predetermined lower position when normal power supply to the safety device 1 is cut off. The reserve power source 5 can be, for instance, a battery.

Power supply from the reserve power source 5 to the safety device 1 is separate from the normal power supply to the safety device 1. The reserve power source 5 is a dedicated power source of the elevator. The reserve power source 5 is thus separate e.g. from a general reserve power source of the building where the elevator is located. However, the reserve power source 5 could serve two or more elevators of the same building.

Power supply from the reserve power source 5 to the safety device 1 allows safe bypassing of the safety device 1 in case of a power failure or a failure of a controller of the elevator and allows thus rescuing people from the elevator car 11 via the uppermost landing or via the lowermost landing. This saves costs, makes the elevator simpler and allows moving of the elevator car 11 by a single technician from outside of the elevator shaft 10.

In the embodiment of the figures, the safety device 1 is attached to the elevator car 1. The safety device 1 is configured to cooperate with a counterpart 18, 19, which is attached to the elevator shaft 10. The counterpart 18 can be attached to the elevator shaft 10 for example via a guiderail 12 of the elevator car 11. The safety device 1 comprises an engagement element 1a, which is configured to be mechanically engaged to the counterpart 18, 19 when the safety device 1 is triggered and the elevator car 11 moves to the predetermined position. The engagement element 1a can be, for instance, a plunger that is movable along a horizontal axis. The engagement element 1a has a first position, in which it cannot engage to the counterpart 18, 19, and a second position, in which it can engage to the counterpart 18, 19. The engagement element 1a is mechanically biased towards the second position and electrically biased towards the first position. The biasing force towards the first position exceeds the biasing force towards the second position. When electrical power is supplied to the safety device 1, the engagement element 1a is thus kept in the first position. When power supply to the safety device 1 is cut off, the mechanical biasing force moves the engagement element 1a to the second position, where it can engage to the counterpart 18, 19.

The safety device 1 can comprise, for instance, one or more springs for biasing the engagement element 1a towards the second position. The safety device 1 can comprise an electromagnet for biasing the engagement element 1a towards the first position. Electrical and mechanical biasing means could be integrated into an electromechanical solenoid.

In the embodiment of FIG. 3, the elevator arrangement comprises an upper counterpart 18 and a lower counterpart 19. The upper counterpart 18 is arranged at the upper end of the elevator shaft 10 for preventing the elevator car 11 from moving above the predetermined upper position. The lower counterpart 19 is arranged at the lower end of the elevator shaft 10 for preventing the elevator car 11 from moving below the predetermined lower position.

The counterpart 18, 19 of the safety device 1 can comprise one or more notches and/or holes 18a, 18b, 18c, 18d, 19a, 19b, 19c, 19d. The notches or holes can be arranged, for instance, in a plate. The engagement element 1a of the safety device 1 is configured to be engaged with one of the notches/holes 18a, 18b, 18c, 18d, 19a, 19b, 19c, 19d. In the embodiment of FIGS. 2 and 3, the lower end of the upper counterpart 18 is provided with a notch 18a. The position of the notch 18a determines a first predetermined upper position for the elevator car 11.

When the power supply to the safety device 1 cut off, the engagement element 1a of the safety device 1 moves to the second position. If the elevator car 11 is at such a position that the engagement element 1a is below the notch 18a of the upper counterpart 18 when the elevator car 11 moves upwards, at some point the engagement element 1a is engaged with the notch 18a. Colliding of the engagement element of 1a with the counterpart 18 is configured to trigger the clamping jaws of the safety gear of the elevator car 11 and to stop the elevator car 11.

When the elevator car 11 is stopped at the first predetermined upper position, it is ensured that a sufficient refuge space is left between the roof of the elevator car 11 and the upper end of the elevator shaft 10.

In the embodiment of FIGS. 2 and 3, the upper counterpart 18 is provided with holes 18b, 18c, 18d that are arranged above the notch 18a of the upper counterpart 18. The engagement element 1a of the safety device 1 can be engaged with any of the holes 18b, 18c, 18d. Each of the holes 18b, 18c, 18d determines a further predetermined upper position for the elevator car 11. If the elevator car 11 is above the first predetermined upper position when the safety device 1 is triggered and consequently the engagement element 1a of the safety device 1 cannot be engaged with the notch 18a, it will be engaged with the first of the holes 18b, 18c, 18d that is above the current position of the engagement element 1a when the elevator car 11 moves upwards. The clamping jaws of the safety gear are triggered in the same way as when the engagement element 1a is engaged with the notch 18a. While stopping of the elevator car 11 at the first predetermined upper position ensures that a sufficient safety space is left above the elevator car 11, the further predetermined upper positions ensure that the elevator car 11 is quickly stopped in case a trigger event occurs when the elevator car 11 is already close to the uppermost landing. The different predetermined upper positions could be implemented by providing the elevator shaft 10 with several upper counterparts.

The lower counterpart 19 can be configured in a similar way. In the embodiment of FIGS. 2 and 3, the uppermost end of the lower counterpart 19 comprises a notch 19a, which determines a first lower predetermined position of the elevator car 11. When the safety device 1 is triggered and the elevator car 11 moves downwards, the engagement element 1a of the safety device 1 will engage to the notch 19a and the safety gear will stop the elevator car 11 at the first predetermined lower position. However, if the elevator car 11 is already below the first predetermined lower position when the safety device 1 is triggered, the engagement element 1a of the safety device will 1 engage to one of the holes 19b, 19c, 19d of the lower counterpart 19. The different predetermined lower positions could be implemented by providing the elevator shaft 10 with several lower counterparts.

The safety device 1 could be constructed in many different ways. For instance, the engagement element 1a could move in a different way than axially. For instance, the engagement element 1a could be arranged to rotate about a pivot point. The safety device 1 could be attached to the elevator shaft 10 instead of the elevator car 11. The elevator car 11 could thus be provided with a counterpart. In case of a low pit and low headroom elevator, the elevator arrangement could be provided with an upper safety device 1 for preventing the elevator car 11 from moving above an upper predetermined position and with a lower safety device 1 for preventing the elevator car 11 from moving below a lower predetermined position. The elevator car 11 could be provided with separate counter parts for the upper safety device and the lower safety device. In case the elevator was provided with only a low pit or a low headroom and either the pit or headroom had sufficient height for forming a refuge space, the arrangement could be provided with a single safety device 1 arranged either at the upper end or the lower end of the elevator shaft 10.

The reserve power source 5 can also be used for supplying reserve power to other devices and components of the elevator. In the embodiment shown in FIG. 2, power is supplied from the reserve power source 5 also to an electrical brake release device 6. With the brake release device 6, a brake of the elevator can be released for allowing the elevator to move either by gravity or by battery-powered drive. Instead of or in addition to supplying power to the brake release device 6, the reserve power source 5 could supply power to a battery-driving function, which allows battery-powered driving of the elevator, for instance for allowing rescuing of people from the elevator car 11 in case of a power failure.

According to an embodiment of the invention, the elevator comprises detection means 9 for detecting presence of a person or an inappropriate object on the roof of the elevator car 11. In addition to or instead of that, the elevator can comprise detection means 21 for detecting the presence of a person or an inappropriate object in the elevator shaft 10, for instance in the pit. According to an embodiment of the invention, the arrangement comprises means 20 for detecting access into the elevator shaft.

The means 9 for detecting the presence of a person or an inappropriate object on the roof of the elevator car 11 could comprise, for instance, an optical detection system, such as a light curtain, a pressure sensitive detection carpet on the roof of the elevator car 11, a floating detection platform comprising a safety switch, or a swinging roof panel provided with a safety switch. The means 21 for detecting presence of a person or an inappropriate object in the elevator shaft 10 could comprise similar means. For instance, the pit could be provided with an optical detection system or a pressure sensitive carpet.

The means 20 for detecting access into the elevator shaft 10 could comprise, for instance, sensors and/or switches arranged in shaft access doors 22. The means could also comprise sensors and/or switches arranged in a hatch providing access onto the roof of the elevator car, in a hatch providing access into the pit or in a hatch providing access onto the side of the elevator car 11.

Any of the detection means 9, 20, 21 or all of the detection means described above could be configured to allow cutting off power supply from the reserve power source 5 to the safety device 1. Such an arrangement is illustrated in FIG. 2, which schematically shows a switch 9a arranged on the roof of the elevator car 11. The switch 9a can be part of detection means 9 detecting presence of a person on the roof of the elevator car 11 or access onto the roof. The switch 9a is part of an electrical circuit supplying electrical power from the reserve power source 5 to the safety device 1. The switch 9a could be arranged for instance in connection with a hatch that provides access onto the roof of the elevator car 11. Alternatively, the switch 9 could be arranged in connection with a floating platform arranged on the roof of the elevator car 11. Opening of the hatch or certain load on the floating platform could be configured to open the switch 9a. Opening of the switch 9a cuts off power supply from the reserve power source 5 to the safety device 1. As a result, the safety device 1 is triggered and moving of the elevator car 11 above a predetermined upper position is prevented. This kind of arrangement ensures safety also when the brakes of the elevator are manually released or when the elevator is driven battery-powered.

Similarly, each of the doors 22 providing access to the elevator shaft 10 could be provided with a switch that is opened when the door is opened to cut off power supply from the reserve power source 5 to the safety device 1.

Power supply from the reserve power source 5 to the safety device 1 could also be controlled by other means than mechanical switches. For instance, detection means 9, 21 for detecting a person on the roof of the elevator car 11 or in the elevator shaft 10 or detection means 20 for detecting access into the elevator shaft 10 could be configured to output status information. The status information could be used for controlling a relay selectively allowing or preventing power supply to the safety device 1. For instance, if the status of the detection means 9 indicates that there is a person or other inappropriate object on the roof of the elevator car 11, the relay cuts off power supply to the safety device 1.

In addition to cutting off the power supply to the safety device 1 when the detection means 9, 20, 21 described above indicate that there is a person on the roof of the elevator car 11 and/or in the elevator shaft 10 or a shaft access door 22 has been opened, releasing of a brake of the elevator could be disabled. Releasing of the brake could also be disabled when the elevator car 11 is at a predetermined danger zone. The brake release device 6 could be connected to the same safety circuit as the safety device 1.

In a method according to the invention, electrical power is supplied to the safety device 1 from the reserve power source 5 when the normal power supply to the safety device 1 has been cut off and the safety device 1 has consequently been triggered. The elevator is provided with a switch 7 and closing of the switch 7 allows power supply to the safety device 1. When power is supplied to the safety device 1, the engagement element 1a of the safety device is biased to the first position and the elevator car 11 can move to the uppermost and lowermost landings. The switch 7 can be operated from outside the elevator shaft 10.

The same reserve power source 5 can be used for supplying power also to the brake release device 6. The elevator can be provided with a switch 8 that can be operated from outside the elevator shaft 10 to allow supply of electrical power to the brake release device 6.

In another elevator arrangement according to the invention it is not necessary to provide the elevator with the safety device 1 defined above. In the other elevator arrangement according to the invention, moving of the elevator car 11 too close to the upper end of the elevator shaft 10 and/or the lower end of the elevator shaft 10 is prevented by disabling releasing of the brake of the motor 14 in certain situations. The elevator arrangement is provided with an electrical brake release device 6 for releasing the brake of the motor 14. The brake release device 6 can comprise a coil that functions as an actuator of the device 6. Releasing of the brake can be prevented either by preventing power supply to the coil or some other actuator of the brake release device 6 or by disabling control signal from a brake release switch to the brake release device 6.

Releasing of the brake can be disabled if an event indicating a risk of a presence of a person in the elevator shaft 10 outside the elevator car 11 is detected. Alternatively, or in addition, releasing of the brake can be disabled when it is detected that the elevator car 11 is at a danger zone.

An event indicating a risk of a presence of a person in the elevator shaft 10 outside the elevator car 11 could be, for instance, a load detected on the roof of the elevator car 11 or opening of a hatch providing access from the elevator car 11 into the elevator shaft 10.

The danger zone can be an area of the elevator shaft 10 where there is not the required free space or clearance between the elevator car 11 and the elevator shaft 10. The danger zone can also mean an area of the elevator shaft 10 where the elevator car 11 moves to an unsafe direction if the brake is released. For instance, in case of a low headroom elevator that could mean an area where the elevator car 11 inherently moves upwards.

According to an embodiment of the invention, releasing of the brake is disabled only if an event indicating a risk of a presence of a person in the elevator shaft 10 outside the elevator car 11 is detected and the elevator car 11 is at a danger zone. For instance, in a low headroom elevator that is provided with a normal pit with a sufficient refuge space, releasing of the brake could thus be allowed in case it is determined that the elevator car 11 will move downwards when the brake is released.

The elevator arrangement can comprise means for detecting said event and/or means for determining the position of the elevator car 11 and means for determining, based on the position of the elevator car 11, whether the elevator car 11 is at the danger zone.

The means for detecting said event can comprise one or more of the detection means 9, 20, 21 for detecting a person in the elevator shaft 10 or access into the shaft 10.

The elevator arrangement where releasing of the brake is disabled in the above-mentioned situations improves the safety of an elevator with a low pit and/or low headroom by preventing releasing of the brake when there is a risk that a person could be squeezed between the elevator shaft 10 and the elevator car 11.

According to an embodiment of the invention, if an event indicating a risk of a presence of a person in the elevator shaft 10 outside the elevator car 11 is detected, the information is stored in a non-volatile memory and releasing of the brake is allowed only after the means detecting such an event has been reset. For instance, if opening of a hatch providing access onto the roof of the elevator car 11 has been detected, releasing of the brake is allowed only after the hatch has been closed and the detection means has been reset.

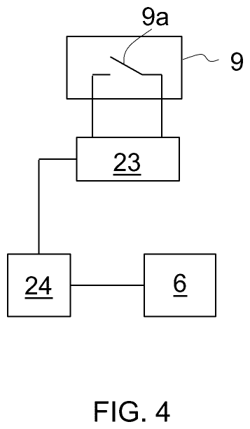

FIG. 4 shows an example how the disabling of the brake release can be implemented. In the example of FIG. 4, the detection means 9 for detecting presence of a person on the roof of the elevator car 11 are connected to a car top safety control board 23. The car top safety control board 23 is connected to an elevator safety control board 24. The elevator safety control board 24 has a safety output disabling or enabling releasing of the brake. Alternatively, the detection means 9 could be connected directly to a circuit supplying power from the reserve power source 5 to the brake release device 6.

1. An elevator arrangement comprising:
an elevator shaft;
an elevator car configured to be moveable in a vertical direction along the elevator shaft;
an electromechanical safety device, electrical power being supplied to the safety device during operation of the elevator, and the safety device being configured to be triggered when power supply to the safety device is cut off, wherein triggering of the safety device is configured to prevent movement of the elevator car above at least one predetermined upper position and/or below at least one predetermined lower position; and
a reserve power source,
wherein the arrangement is configured to allow power supply from the reserve power source to the safety device for allowing moving of the elevator car above the at least one predetermined upper position and/or below the at least one predetermined lower position when normal power supply to the safety device is cut off.

2. The elevator arrangement according to claim 1, wherein the arrangement comprises a detector configured to detect presence of a person or an inappropriate object on the roof of the elevator car and/or access onto the roof of the elevator car.

3. The elevator arrangement according to claim 1, wherein the arrangement comprises a detector configured to detect presence of a person or an inappropriate object in the elevator shaft below the elevator car.

4. The elevator arrangement according to claim 1, wherein the arrangement comprises a detector configured to detect access into the elevator shaft.

5. The elevator arrangement according to claim 1, wherein the arrangement is configured to prevent power supply from the reserve power source to the safety device when at least one of the following events is detected:
presence of a person or an inappropriate object on the roof of the elevator car;
access onto the roof of the elevator car;
presence of a person or an inappropriate object in the elevator shaft below the elevator car; and
access into the elevator shaft.

6. The elevator arrangement according to claim 1, wherein the arrangement comprises a device and/or a function for allowing releasing of a brake of the elevator using power supplied from the reserve power source.

7. The elevator arrangement according to claim 1, wherein the safety device is configured to cooperate with a counterpart and one of the safety device and the counterpart is fastened to the elevator car and the other of the safety device and the counterpart is fastened to the elevator shaft.

8. The elevator arrangement according to claim 7, wherein the arrangement comprises an upper counterpart arranged at an upper end of the elevator shaft and a lower counterpart arranged at a lower end of the elevator shaft or an upper safety device arranged at the upper end of the elevator shaft and a lower safety device arranged at the lower end of the elevator shaft.

9. The elevator arrangement according to claim 7, wherein the safety device comprises an engagement element configured to engage to the counterpart when the safety device is triggered and the elevator car moves to the at least one predetermined lower position or the at least one predetermined upper position.

10. The elevator arrangement according to claim 1, wherein the arrangement is configured to disable releasing of a brake of the elevator in at least one of the following cases:
a person or an inappropriate object on the roof of the elevator car is detected;
a person or an inappropriate object in the elevator shaft below the elevator car is detected;
the elevator car is at an upper danger zone extending to a predetermined distance from the upper end of the elevator shaft;
the elevator car is at a lower danger zone extending to a predetermined distance from the lower end of the elevator shaft;
a person or an inappropriate object on the roof of the elevator car is detected and the elevator car is at an upper danger zone extending to a predetermined distance from the upper end of the elevator shaft; and
a person or an inappropriate object below the elevator car is detected and the elevator car is at a lower danger zone extending to a predetermined distance from the lower end of the elevator shaft.

11. A method of operating an elevator, the elevator comprising an electromechanical safety device, electrical power being supplied to the safety device during operation of the elevator, and the safety device being configured to be triggered when power supply to the safety device is cut off, triggering of the safety device being configured to prevent movement of the elevator car above at least one predetermined upper position and/or below at least one predetermined lower position,
wherein in case normal power supply to the safety device is cut off, supplying electrical power to the safety device from a reserve power source to allow the elevator car to move above the at least one predetermined upper position and/or below the at least one predetermined lower position.

12. An elevator arrangement comprising:
an elevator shaft;
an elevator car configured to be moveable in a vertical direction along the elevator shaft;
a motor for moving the elevator car in the elevator shaft, the motor comprising a brake;
an electrical brake release device for releasing the brake of the motor; and
a detector configured to detect at least one event indicating a risk of a presence of a person in the elevator shaft outside the elevator car and/or means for determining the position of the elevator car and means for determining, based on the position of the elevator car, whether the elevator car is at a danger zone,
wherein the arrangement is configured to prevent releasing of the brake of the motor when at least one event indicating a risk of a presence of a person in the elevator shaft outside the elevator car is detected and/or when the elevator car is at a danger zone.

13. The elevator arrangement according to claim 2, wherein the arrangement comprises a detector configured to detect presence of a person or an inappropriate object in the elevator shaft below the elevator car.

14. The elevator arrangement according to claim 2, wherein the arrangement comprises a detector configured to detect access into the elevator shaft.

15. The elevator arrangement according to claim 3, wherein the arrangement comprises a detector configured to detect access into the elevator shaft.

16. The elevator arrangement according to claim 2, wherein the arrangement is configured to prevent power supply from the reserve power source to the safety device when at least one of the following events is detected:
presence of a person or an inappropriate object on the roof of the elevator car;
access onto the roof of the elevator car;
presence of a person or an inappropriate object in the elevator shaft below the elevator car; and
access into the elevator shaft.

17. The elevator arrangement according to claim 3, wherein the arrangement is configured to prevent power supply from the reserve power source to the safety device when at least one of the following events is detected:
presence of a person or an inappropriate object on the roof of the elevator car;
access onto the roof of the elevator car;
presence of a person or an inappropriate object in the elevator shaft below the elevator car; and
access into the elevator shaft.

18. The elevator arrangement according to claim 4, wherein the arrangement is configured to prevent power supply from the reserve power source to the safety device when at least one of the following events is detected:
presence of a person or an inappropriate object on the roof of the elevator car;
access onto the roof of the elevator car;
presence of a person or an inappropriate object in the elevator shaft below the elevator car; and
access into the elevator shaft.

19. The elevator arrangement according to claim 2, wherein the arrangement comprises a device and/or a function for allowing releasing of a brake of the elevator using power supplied from the reserve power source.

20. The elevator arrangement according to claim 3, wherein the arrangement comprises a device and/or a function for allowing releasing of a brake of the elevator using power supplied from the reserve power source.
